(19) United States
(12) Patent Application Publication
(10) Pub. No.: US 2023/0341061 A1
(43) Pub. Date: Oct. 26, 2023

(54) DOUBLE-GUIDED DART CHECK VALVE FOR SURFACE HYDRAULIC FRACTURING OPERATIONS

(71) Applicant: Halliburton Energy Services, Inc., Houston, TX (US)

(72) Inventor: Brad Robert Bull, Houston, TX (US)

(21) Appl. No.: 17/660,428

(22) Filed: Apr. 25, 2022

(51) Int. Cl. F16K 15/06; E21B 43/26

(52) U.S. Cl. CPC F16K 15/063; E21B 43/2607; E21B 34/10

(57) ABSTRACT

A check valve assembly may include a guide for a closure member on an upstream side the closure member and may include guide members disposed on both the upstream and downstream sides of the closure member. The closure member may include a conically shaped head of a poppet, and elongated stems may extend from the head to the upstream and downstream guide members. The guide members may include bores to receive the stems along a longitudinal axis of the check valve assembly on opposite sides of the closure member. This arrangement distributes the wear on a valve seat and the closure member more uniformly and may increase the service life of the check valve assembly. The check valve assembly may operate in surface locations or may be deployed downhole.

### BACKGROUND

The present disclosure relates generally to fluid control valves and, more particularly, to check valves for hydraulic fracturing operations. Embodiments of the disclosure include check valves that may be positioned between a hydraulic fracturing pump and wellbore to ensure fluid flow in an intended direction.

Various techniques may be employed to stimulate the flow of hydrocarbons into a wellbore. For example, a commonly used stimulation technique involves creating and extending fractures in a subterranean formation surrounding the wellbore. The fractures provide flow channels through which hydrocarbons may flow from the formation into the wellbore. To form the fractures, a fracturing fluid may be pumped into the formation at a sufficient pressure to create and extend fractures. Fracturing equipment operates over a range of pressures and injection rates, which can reach up to 100 megapascals (15,000 psi) and 265 liters per second (9.4 cu ft/s) (100 barrels per minute). Solid proppant materials, such as sand, are commonly suspended in the fracturing fluid such that, upon introducing the fracturing fluid into the fractures, the proppant is deposited to prevent the fractures from closing once the increased pumping pressures is removed. In such a hydraulic fracturing operation, tools and equipment are operated both at the surface and within the wellbore to circulate the fracturing fluid along the intended flow path. The control of the fluid circulation paths is achieved in many instances by check valves that open when the fracturing fluid flows in the intended direction and close when the fracturing fluid flows in the opposite direction. The technological development of hydraulic fracturing operations has led to increased demands on the check valves. For example, the duty cycle for some check valves has increased, and more abrasive fracturing fluids are being pumped through the check valves at higher pump rates. These developments have shortened the typical maintenance interval and overall operational life of check valves used in these hydraulic fracturing operations.

### BRIEF DESCRIPTION OF THE DRAWINGS

The disclosure is described in detail hereinafter, by way of example only, on the basis of examples represented in the accompanying figures, in which:

FIG. 1 is a partial, cross-sectional side view of a hydraulic fracturing system for a wellbore including check valve assemblies in accordance with the present disclosure disposed at both surface locations and downhole locations within the wellbore;

FIG. 2 is a partial, cross-sectional side view of one of the check valve assemblies of FIG. 1, illustrating a guide member on both upstream and downstream sides of dart-shaped poppet including a conically shaped head or closure member;

FIG. 3 is a partial, cross-sectional side view of another embodiment of a check valve assembly illustrating a guide member only on the upstream side of the closure member;

FIG. 4 is a flowchart illustrating a procedure operating the check valves of the present disclosure in a wellbore operation; and

FIG. 5 is a partial, cross-sectional side view of a prior-art embodiment of a check valve assembly illustrating a dart guide only on the downstream side of the closure member.

### DETAILED DESCRIPTION

Check valves may have a service life in hydraulic fracturing operations that last as little as thirty days. The present disclosure describes a check valve assembly including a guide for a closure member on both the upstream and downstream sides of the closure member. The guides may be provided “in-line,” e.g., along a longitudinal axis of the valve assembly on opposite sides of the closure member. This arrangement may serve to distribute the wear on a valve seat more uniformly and may increase the service life of the valve assembly. The valve assembly may operate in surface locations or may be deployed downhole.

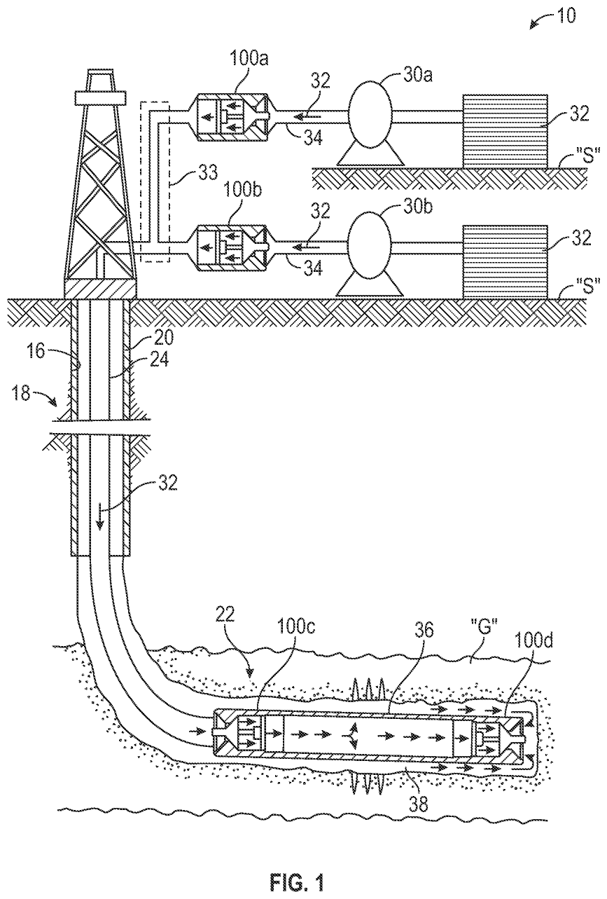

FIG. 1 illustrates a wellbore system 10 including a plurality of check valve assemblies 100a, 100b, 100c, 100d (generally or collectively check valve assemblies 100) in accordance with aspects of the present disclosure. Wellbore system 10 includes a wellbore 16 extending from a surface location “S” through a geologic formation “G.” While wellbore 16 is illustrated extending from a terrestrial surface location “S,” the principles described herein are equally applicable to subsea drilling operations that employ floating or sea-based platforms and rigs, without departing from the scope of the disclosure. Wellbore 16 has a substantially vertical section 18, the upper portion of which has installed therein a casing string 20 that is cemented within wellbore 16. Wellbore 16 also has a substantially horizontal section 22 that extends through a hydrocarbon bearing geologic formation “G.” As illustrated, substantially horizontal section 22 of wellbore 16 is open hole. Positioned within wellbore 16 and extending from the surface location “S” is a tubing string 24. Tubing string 24 provides a conduit for fluids to travel between the surface location “S” and the geologic formation “G.”

At the surface location “S,” a plurality of pumps 30a, 30b are provided for injecting a fracturing fluid 32 into the wellbore 16. As illustrated in FIG. 1, each pump 30a, 30b is coupled to an individual source of fracturing fluid 32, and in other embodiments, each pump 30a, 30b is coupled to a common source of fracturing fluid 32. The fracturing fluid 32 may contains an abrasive proppant, which both facilitates an initial creation of the fracture and serves to keep the fracture “propped” open after the creation of the fracture. Multiple pumps 30a, 30b are often employed simultaneously in large scale hydraulic fracturing operations to achieve the necessary flow rates and pressures, sometimes in the range of 10,000 to 15,000 psi or more. These pumps 30a, 30b may be linked to one another through a common manifold 33, which mechanically collects and distributes the combined output of the individual pumps 30a, 30b. Although only two pumps 30a, 30b are illustrated, hydraulic fracturing operations often proceed with twenty or more pumps 30a, 30b coupled through a common manifold 33.

Check valves 100a, 100b are disposed at the surface location “S” and are coupled downstream of pumps 30a, 30b, respectively. The “downstream” and “upstream” directions described herein refer to the direction flow that is permitted through the check valve assemblies 100. The check valves 100a, 100b are coupled in a flow line 34 and permit flow of the fracturing fluid 32 from the pumps 30a, 30b to the manifold 33, and prohibit reverse flow from the manifold 33 to the pumps 30a, 30b. Since pumps 30a, 30b are often reciprocating piston pumps that operate with a pressure stroke and a suction stroke, the check valves 100a, 100b may prevent any fracturing fluid from being drawn from the manifold 33 into pumps 30a, 30b during their suction strokes. In addition to the check valves 100a, 100b at the surface location “S,” check valves 100c, 100d may have applications in a downhole setting in accordance with aspects of the present disclosure. Check valve 100c is arranged to permit flow from tubing string 24 into a jetting tool 36 and check valve 100d is arranged to receive flow from an annulus 38 defined around the jetting tool 36.

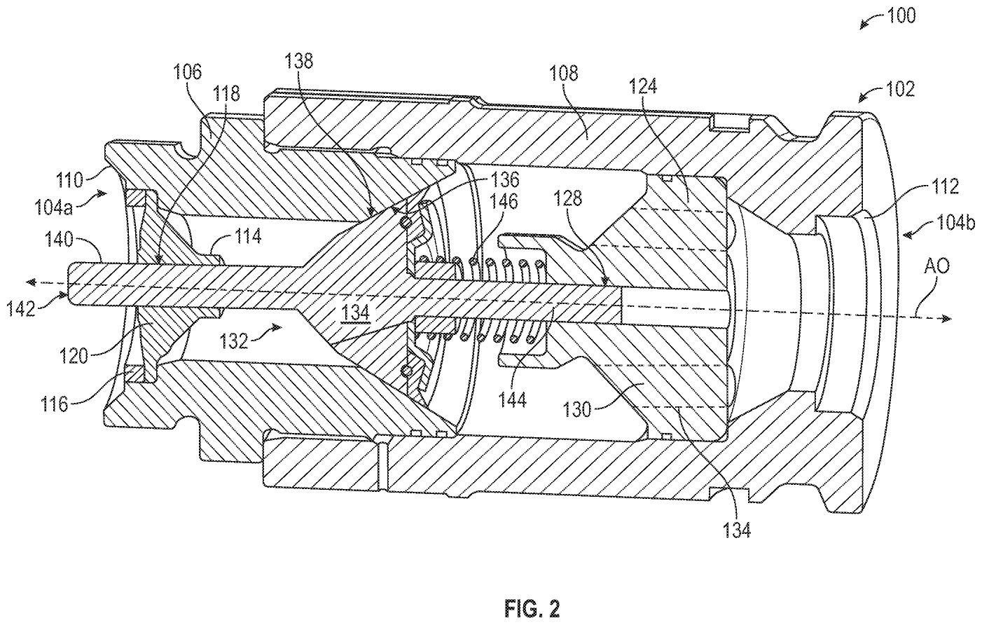

Referring to FIG. 2, a check valve assembly 100 is illustrated, which may be employed as any of the check valve assemblies 100a, 100b, 100c, 100d (FIG. 1) described above. The check valve assembly 100 generally includes an outer housing 102 defining an upstream end 104a, a downstream end 104b and a longitudinal axis A0 extending centrally therethrough. The housing 102 is constructed of an upstream housing member 106 and a downstream housing member 108, which may be fixedly coupled to one another by threads or other coupling mechanisms. The upstream housing member 106 defines an inlet 110 at the upstream end 104a and the downstream housing member 108 defines an outlet 112 at the downstream end 104b.

An upstream guide member 114 is disposed within the upstream housing member 106 and may be secured therein by welds, threads, pins or other similar mechanisms. A seal 116 is provided at the inlet 110 to facilitate connection of the check valve assembly 100 in flow line 34 (FIG. 1) or in another location within the wellbore system 10. The seal 116 may be a portion of a Hammer Lug Union or another type of pipe coupling. The upstream guide member includes a central longitudinal bore 118 and a plurality of circumferentially spaced flow passages 120 extending therethrough. The flow passages 120 may distribute fluid flow evenly around the longitudinal axis A0. Similar to the upstream guide member 114, a downstream guide member 124 is disposed within the downstream housing member 108 and includes a central longitudinal bore 128 and circumferentially spaced radial flow passages 130 extending therethrough. A poppet 132 is generally disposed between upstream guide member 114 and downstream guide member 124 and includes a head 134 operable to engage a valve seat 136 defined by the upstream housing member 106. The head 134 of the poppet 132 includes a conically shaped face 138 in the upstream direction. Often, the poppet 132 may be referred to as a “dart” due to the conical shape of the head 134.

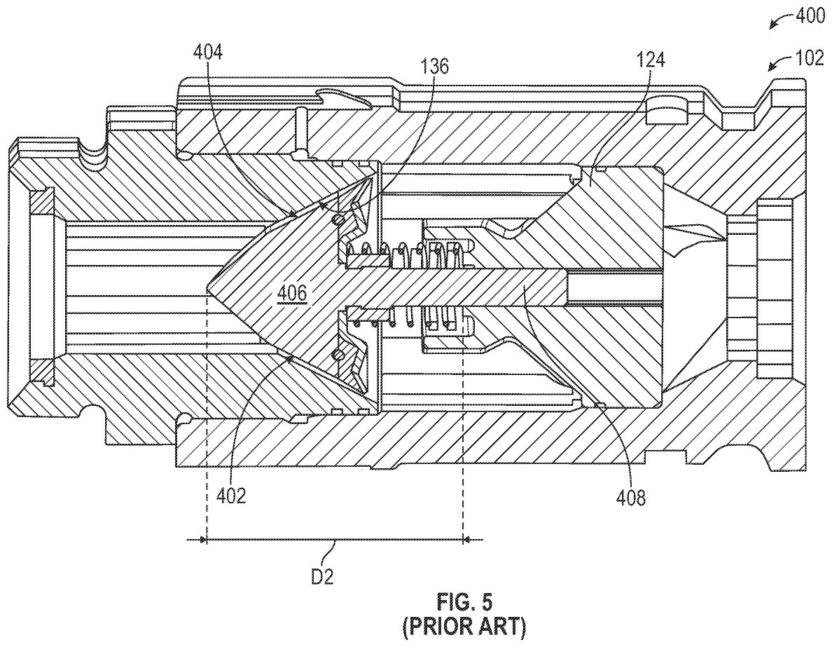

An upstream stem 140 of the poppet 132 extends from the head 134 into the central bore 118 of the upstream guide member 114. The upstream stem 140 may be closely fit within central bore 118 bore such that the central bore 118 may serve as a linear bearing, and in some embodiments, a bearing sleeve (not shown) may be provided within the central bore 118. As illustrated, the upstream stem 140 extends through the entire length of the upstream guide member 114 such that a leading end 142 of the upstream stem 140 is disposed on an upstream side of the upstream guide member 114. In other embodiments (not shown) the leading end 142 may be disposed within the central bore 118 of the upstream guide member 114. Thus, the upstream guide member 114 may prevent or discourage any lateral movement of the poppet 132 caused by turbulent fluid flow over the leading end 142. The upstream stem 140 may be constructed as rigid, elongated rod extending from a radial center of the head 134. The conically shaped face 138 of the head 134 may terminate at upstream stem 140, such that the conically shaped face 138 does not define a point (see, e.g., FIG. 5) at the radial center of the head 134 that could produce unpredictable flow patterns. The leading end 142 defines a generally flat face orthogonal to the longitudinal axis A0.

A downstream stem 144 of the poppet 132 extends from the head 134 into the central bore 128 of the downstream guide member 124. The downstream stem 144 may be closely fit within central bore 128. A spring 146 or other biasing member extends between the head 134 of the poppet 132 and the downstream guide member 124 to bias the poppet 132 into engagement with the valve seat 136. As illustrated in FIG. 2, the upstream stem 140 and the downstream stem 144 are arranged in line about the longitudinal axis A0.

Together, the guide members 114, 124 together function to guide poppet 132 as the poppet 132 translates longitudinally within the outer housing 102. For example, the poppet 132 may be translated in a downstream direction against the bias of the spring 146 to move the head 134 away from the valve seat 136. When a sufficient fluid pressure is applied to the conically shaped face 138, the poppet 132 translates in a downstream direction such that fluid flow is permitted between the conically shaped face 138 and the valve seat 136, thereby permitting fluid flow through the check valve assembly 100. The guide members 114, 124 disposed on both the upstream and downstream sides of the head 134 maintains the head 134 centered along the longitudinal axis A0 during operation. Thus, the wear on the head 134 and the valve seat 136 is distributed evenly around the sealing interface defined by the engagement of the head 134 with the valve seat 136. This arrangement has been found to nearly double the service life of a check valve assembly compared to check valve assemblies including only a downstream guide member 124 where a head is cantilevered along a downstream stem (see, e.g., FIG. 5).

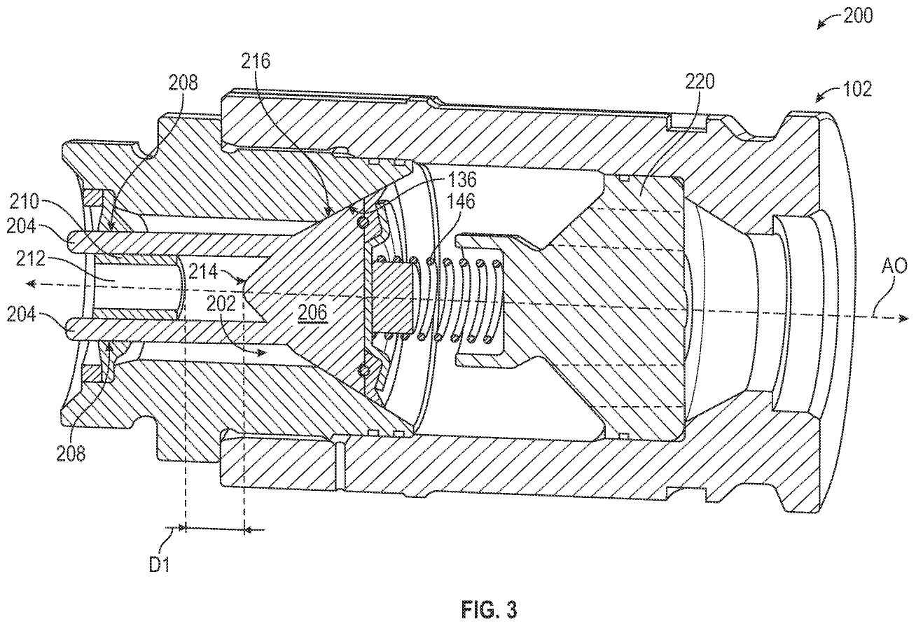

Referring not to FIG. 3, an alternate embodiment of a check valve assembly 200 includes a poppet 202 with a plurality of radially spaced upstream stems 204 disposed within outer housing 102. As illustrated in FIG. 3, no downstream stems are provided on the poppet 202, but one or more downstream stems may be provided (see downstream stem 144, FIG. 2) without departing from the scope of the disclosure. The upstream stems 204 may include a radial array of at least three upstream stems 204 that extend from a head 206 of the poppet 202 through a corresponding array of bores 208 defined in an upstream guide member 210. A central flow path 212 is defined through the upstream guide member 210 to permit fluid flow to a conically shaped face 216 of the head 206. Spring 146 or other biasing member extends between the head 206 of the poppet 202 and a spring support member 220 to bias the poppet 202 into engagement with the valve seat 136. A leading end 214 of the head 206 is generally centered along the central longitudinal axis A0 and distributes flow around the conically shaped face 216. When a sufficient fluid pressure is applied to the conically shaped face 216, the poppet 202 translates in a downstream direction against the bias of the spring 146, thereby separating the head 206 from the valve seat 136.

The radial array of upstream stems 204 spaced around the leading end 214 of the head 214 provides robust lateral support to the head of the poppet 202 and maintains the central position of the head 214 in operation. At least since the stems 204 extend in an upstream direction, a distance “D1” between the leading end 214 of the head 206 where fluid forces are applied and the upstream guide member 210 where the stems are supported may be minimized. The centralized location of the head 206 reduces wear, prevents leakage a requires less maintenance for the check valve assembly 200.

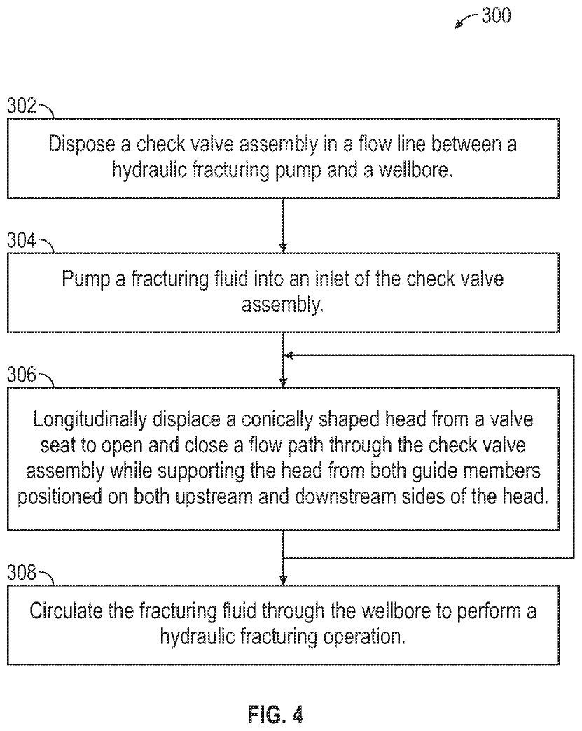

Referring to FIG. 4, and with reference to FIGS. 1 through 3, an example operating procedure 300 is described for conducting a hydraulic fracturing operation with the check valve assemblies 100, 200 described above. Initially at step 302, a check valve assembly 100, 200 may be disposed in a flow line 34 downstream of a hydraulic fracturing pump 30a, 30b. For example, the check valve assembly 100, 200 may be coupled in a flow line 34 between a hydraulic fracturing pump 30a, 30b and a wellbore 16 or between a fracturing pump 30a, 30b and a manifold 33 at a surface location “S.” Next, at step 304, the fracturing pumps 30a, 30b may be operated to pump a fracturing fluid 32 to an inlet 110 of the check valve assembly 100, 200. At step 306, the high pressure imparted to the fracturing fluid 32 during a pressure stroke of the pump 30a, 30b may be applied to the conically shaped face 138, 216 of the head 134, 206 of the poppet 132, 202 to longitudinally displace the head 134, 206 from the valve seat 136 and open a flow path through the check valve assembly 100, 200. As the head 134, 206 is longitudinally displaced, the head 134, 206 is supported by the upstream guide member 114, 210 and optionally a downstream guide member 124 ensuring that the head 134, 206 maintains a central radial position with respect to the valve seat 136. When the pump 30a, 30b is operated through a suction stroke, the head 134, 206 is longitudinally displaced back toward the valve seat 136 under the bias of the spring 146. Again, the head 134, 206 supported by the upstream guide member 114, 210 and optionally a downstream guide member 124 ensuring that the head 134, 206 maintains engages the valve seat 136 in a central radial position. Step 306 may be repeated until the fracturing fluid 32 moving through the check valve assembly 100, 200 may be circulated downhole through the wellbore 16 to perform a hydraulic fracturing operation (step 308).

Referring now to FIG. 5, a conventional check valve assembly 400 is illustrated. The check valve 400 may include housing 102 defining a valve seat 136 as described above. A poppet 402 includes a conically shaped face 404 on an upstream side of a head 406 and a downstream stem 408 extending from a downstream side of the head 406 to a downstream guide member 124. The head 406 of the poppet 402 in the conventional check valve assembly 400 is not supported on the upstream side. A cantilever distance “D2” between a leading end 412 of the head 406 where fluid forces are applied and the downstream guide member 124 where the stem 408 is supported extends across the valve seat 136 and spring 146. Thus, the cantilever distance D2 may be greater than the minimized cantilever distance D1 (FIG. 3) of a head 206 supported on an upstream side. The head 406 of the conventional check valve assembly may thus be laterally displaced more readily in operation and experience greater wear than the check valve assemblies 100, 200 described above.

The aspects of the disclosure described below are provided to describe a selection of concepts in a simplified form that are described in greater detail above. This section is not intended to identify key features or essential features of the claimed subject matter, nor is it intended to be used as an aid in determining the scope of the claimed subject matter.

In one aspect, the disclosure is directed to a check valve assembly for use hydraulic fracturing operations. The check valve assembly includes a tubular housing defining an upstream end, a downstream end and a longitudinal axis extending therethrough. A valve seat is defined within the tubular housing. A closure member defines a conically shaped face for engaging the valve seat to form a seal therewith and the closure member is disposed within the tubular housing such that the conically shaped face is oriented in an upstream direction. A biasing member is operably coupled to the closure member to bias the conically shaped face of the closure member into engagement with the valve seat. An upstream stem extends in the upstream direction from the closure member and an upstream guide member is disposed in the tubular housing on a upstream side of the closure member, the upstream guide member including a longitudinal bore receiving the upstream stem therein.

In one or more embodiments, the assembly further includes a downstream stem extending in a downstream direction from the closure member and a downstream guide member disposed in the tubular housing on a downstream side of the closure member. The downstream guide member may include a longitudinal bore receiving the downstream stem therein. The upstream stem and the downstream stem may be aligned along the longitudinal axis. In some embodiments, the upstream stem extends through the upstream guide member such that a leading end of the upstream stem is disposed on an upstream side of the upstream guide member. In some embodiments, the upstream guide member includes a plurality of flow passages extending therethrough circumferentially spaced around the longitudinal bore of the upstream guide member.

In some embodiments, the assembly further includes at least one additional stem extending from the closure member independently of the upstream stem, the at least one additional stem received within at least one longitudinal bore independent of the longitudinal bore in which the upstream stem is received. In some embodiments, the at least one additional stem includes a downstream stem extending in a downstream direction, and the downstream stem may be axially aligned with the upstream stem.

In one or more embodiments, the upstream stem comprises an elongated rod extending from a radial center of the closure member, and the conically shaped face extends from the valve seat to the elongated rod. In some embodiments, a leading end of the elongated rod defines a generally flat face orthogonal to the longitudinal axis.

In another aspect, the disclosure is directed to a hydraulic fracturing system. The system includes a source of a fracturing fluid, a hydraulic fracturing pump fluidly coupled to source of fracturing fluid, a flow line fluidly coupled downstream of the hydraulic fracturing pump, and a tubular housing coupled within the flow line. The tubular housing defines an upstream end, a downstream end and a longitudinal axis extending therethrough. A valve seat is defined within the tubular housing and a closure member defines a conically shaped face for selectively engaging the valve seat to form a seal therewith. The closure member is disposed within the tubular housing such that the conically shaped face is oriented in an upstream direction. An upstream stem extends in the upstream direction from the closure member and an upstream guide member is disposed in the tubular hosing on a upstream side of the closure member. The upstream guide member includes a longitudinal bore receiving the upstream stem therein.

In some embodiments, the system further includes a downstream stem extending in a downstream direction from the closure member and a downstream guide member disposed in the tubular hosing on a downstream side of the closure member. The downstream guide member includes a longitudinal bore receiving the downstream stem therein. In some embodiments, the system further includes a biasing member disposed between the closure member and the downstream guide member, wherein the biasing member biases the closure member in an upstream direction into engagement with the valve seat. The upstream stem and the downstream stem may be aligned with one another along the longitudinal axis of the tubular housing.

In one or more embodiments, the tubular housing is coupled in the flow line between the hydraulic fracturing pump and a manifold at a surface location. The hydraulic fracturing pump may be a reciprocating piston pump and the system may further include at least one additional hydraulic fracturing pump fluidly coupled to the manifold. In some embodiments, the system further includes a tubular string extending into a wellbore, the tubing string fluidly coupled to the tubular housing and a downhole jetting tool.

According to another aspect, the disclosure is directed to a method for hydraulic fracturing. The method includes coupling a check valve assembly in a flowline downstream of a hydraulic fracturing pump, operating the hydraulic fracturing pump to pump a fracturing fluid into an upstream end of the check valve assembly, longitudinally displacing a closure member of the check valve assembly to open a flow path through the check valve assembly, while longitudinally displacing the closure member, supporting the closure member with an upstream stem extending from the closure member to a longitudinal bore of an upstream guide member disposed on the upstream side of the closure member and flowing the fracturing fluid into a wellbore to conduct a hydraulic fracturing operation.

In one or more embodiments, the method further includes supporting the closure member with a downstream stem extending from the closure member to a longitudinal bore of a downstream guide member disposed on the downstream side of the closure member. The method may further include longitudinally displacing the closure member with a biasing member to engage the closure member with a valve seat and close the flow path through the check valve assembly.

The Abstract of the disclosure is solely for providing the United States Patent and Trademark Office and the public at large with a way by which to determine quickly from a cursory reading the nature and gist of technical disclosure, and it represents solely one or more examples.

While various examples have been illustrated in detail, the disclosure is not limited to the examples shown. Modifications and adaptations of the above examples may occur to those skilled in the art. Such modifications and adaptations are in the scope of the disclosure.

1-4. (canceled)

5. The system of claim 10, wherein the upstream guide member includes a plurality of flow passages extending therethrough circumferentially spaced around the longitudinal bore of the upstream guide member.

6. The system of claim 10, further comprising at least one additional stem extending from the closure member independently of the upstream stem, the at least one additional stem received within at least one longitudinal bore independent of the longitudinal bore in which the upstream stem is received.

7. The system of claim 6, wherein the at least one additional stem includes a downstream stem extending in a downstream direction, and wherein the downstream stem is axially aligned with the upstream stem.

8. The system of claim 10, wherein the upstream stem comprises an elongated rod extending from a radial center of the closure member, and wherein the conically shaped face extends from the valve seat to the elongated rod.

9. The system of claim 8, wherein a leading end of the elongated rod defines a generally flat face orthogonal to the longitudinal axis.

10. A hydraulic fracturing system, comprising:
a source of a fracturing fluid;
a hydraulic fracturing pump fluidly coupled to source of fracturing fluid;
a flow line fluidly coupled downstream of the hydraulic fracturing pump;
a tubular housing coupled within the flow line, the tubular housing defining an upstream end, a downstream end and a longitudinal axis extending therethrough;
a valve seat defined within the tubular housing;
a closure member defining a conically shaped face for selectively engaging the valve seat to form a seal therewith, the closure member disposed within the tubular housing such that the conically shaped face is oriented in an upstream direction;
an upstream stem extending in the upstream direction from the closure member; and
an upstream guide member disposed in the tubular housing on a upstream side of the closure member, the upstream guide member including a longitudinal bore receiving the upstream stem therein,
wherein the upstream stem extends through the entire longitudinal bore of the upstream guide member such that a leading end of the upstream stem is disposed on an upstream side of the upstream guide member.

11. The system according to claim 10, further comprising a downstream stem extending in a downstream direction from the closure member and a downstream guide member disposed in the tubular housing on a downstream side of the closure member, the downstream guide member including a longitudinal bore receiving the downstream stem therein.

12. The system according to claim 11, further comprising a biasing member disposed between the closure member and the downstream guide member, wherein the biasing member biases the closure member in an upstream direction into engagement with the valve seat.

13. The system according to claim 11, wherein the upstream stem and the downstream stem are aligned with one another along the longitudinal axis of the tubular housing.

14. The system according to claim 10, wherein the tubular housing is coupled in the flow line between the hydraulic fracturing pump and a manifold at a surface location.

15. The system according to claim 14, wherein the hydraulic fracturing pump is a reciprocating piston pump.

16. The system according to claim 15, further comprising at least one additional hydraulic fracturing pump fluidly coupled to the manifold.

17. The system according to claim 10, further comprising a tubular string extending into a wellbore, the tubing string fluidly coupled to the tubular housing and a downhole jetting tool.

18. A method for hydraulic fracturing, comprising:
coupling a check valve assembly in a flowline downstream of a hydraulic fracturing pump;
operating the hydraulic fracturing pump to pump a fracturing fluid into an upstream end of the check valve assembly;
longitudinally displacing a closure member of the check valve assembly to open a flow path through the check valve assembly;
while longitudinally displacing the closure member, supporting the closure member with an upstream stem extending from the closure member to a longitudinal bore of an upstream guide member disposed on the upstream side of the closure member, wherein the upstream stem extends through the entire longitudinal bore of the upstream guide member such that a leading end of the upstream stem is disposed on an upstream side of the upstream guide member; and
flowing the fracturing fluid into a wellbore to conduct a hydraulic fracturing operation.

19. The method according to claim 18, further comprising supporting the closure member with a downstream stem extending from the closure member to a longitudinal bore of a downstream guide member disposed on the downstream side of the closure member.

20. The method according to claim 18, further comprising longitudinally displacing the closure member with a biasing member to engage the closure member with a valve seat and close the flow path through the check valve assembly.
